(19) United States
(12) Patent Application Publication
(10) Pub. No.: US 2023/0186092 A1
(43) Pub. Date: Jun. 15, 2023

(54) LEARNING DEVICE, LEARNING METHOD, COMPUTER PROGRAM PRODUCT, AND LEARNING SYSTEM

(71) Applicant: KABUSHIKI KAISHA TOSHIBA, Tokyo (JP)

(72) Inventor: Yusuke NATSUI, Yokohama Kanagawa (JP)

(73) Assignee: KABUSHIKI KAISHA TOSHIBA, Tokyo (JP)

(21) Appl. No.: 17/822,758

(22) Filed: Aug. 26, 2022

(30) Foreign Application Priority Data
Dec. 14, 2021 (JP) 2021-202810

(51) Int. Cl. G06N 3/08

(52) U.S. Cl. CPC G06N 3/082; G06V 10/764

(57) ABSTRACT

A learning device according to one embodiment includes one or more hardware processors. The one or more hardware processors function as an output control unit, a receiving unit, and a training unit. The output control unit serves to output pieces of model information including respective accuracy and performance of learning models with different sizes. The receiving unit serves to receive input made by a user. The training unit serves to train one of the learning models represented by one of the pieces of model information selected by the user.

### CROSS-REFERENCE TO RELATED APPLICATIONS

This application is based upon and claims the benefit of priority from Japanese Patent Application No. 2021-202810, filed on Dec. 14, 2021; the entire contents of which are incorporated herein by reference.

### FIELD

Embodiments described herein relate generally to a learning device, a learning method, a computer program product, and a learning system.

### BACKGROUND

Significant performance improvements have been achieved in fields, such as image recognition, speech recognition, and text processing by utilizing neural network (Neural Network) models. Methods using deep learning techniques are often used for neural network models.

Network models obtained by deep learning are referred to as “deep neural network (DNN) models”, and have much calculation amount because convolution processing is performed at each layer. In addition, methods using deep learning have a large amount of weight coefficient data. This may result in increase in memory usage and transfer amount when the neural network model is operated on certain hardware. For this reason, techniques to reduce the size of DNN models have been disclosed.

However, the conventional techniques require the user to designate various performance-related parameters, such as the computation amount, processing time, power consumption, size, and data transfer amount, to provide a trained model with accuracy and performance desired by the user. In addition, it is required to execute training for each of the models to derive the accuracy of the model. This procedure requires a high processing load. In other words, it is difficult for conventional techniques to easily provide trained models with accuracy and performance desired by the user.

### BRIEF DESCRIPTION OF THE DRAWINGS

FIG. 1 is a schematic diagram of a learning system;

FIG. 2 is an explanatory diagram of a learning model;

FIG. 3 is a schematic diagram of a data structure of model management;

FIG. 4 is an explanatory diagram of generation of untrained models;

FIG. 5 is an explanatory diagram of generation of untrained models;

FIG. 6 is an explanatory diagram of model adjustment;

FIG. 7 is an explanatory diagram of a trained model;

FIG. 8A is a schematic diagram of a display screen;

FIG. 8B is a schematic diagram of a display screen;

FIG. 8C is a schematic diagram of a display screen;

FIG. 8D is a schematic diagram of a display screen;

FIG. 8E is a schematic diagram of a display screen;

FIG. 8F is a schematic diagram of a display screen;

FIG. 8G is a schematic diagram of a display screen;

FIG. 9 is a flowchart of flow of information processing; and

FIG. 10 is a diagram of hardware configuration.

### DETAILED DESCRIPTION

A learning device according to one embodiment includes one or more hardware processors. The one or more hardware processors are configured to function as an output control unit, a receiving unit, and a training unit. The output control unit serves to output pieces of model information including respective accuracy and performance of learning models with different sizes. The receiving unit serves to receive input made by a user. The training unit serves to train one of the learning models represented by one of the pieces of model information selected by the user.

A learning device, a learning method, a computer program product, and a learning system according to the present embodiment will be described in detail below with reference to the accompanying drawings.

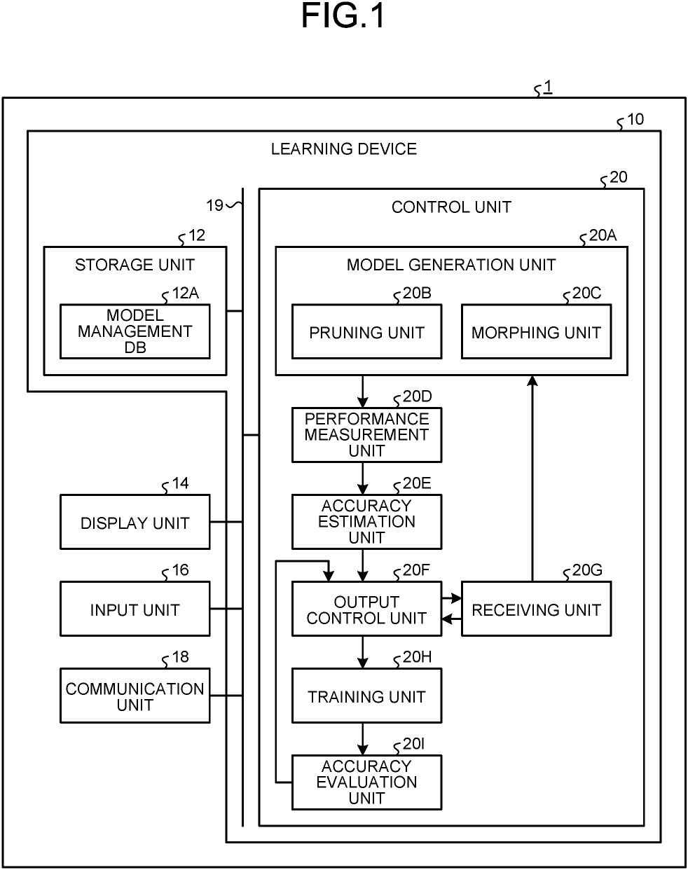

FIG. 1 is a schematic diagram of an example of a learning system 1 according to the present embodiment.

The learning system 1 includes a learning device 10, a display unit 14, an input unit 16, and a communication unit 18. The learning device 10, the display unit 14, the input unit 16, and the communication unit 18 are connected to be able to communicate with each other via a bus 19 or the like.

The display unit 14 and the input unit 16 may have any structure as long as they are connected to the learning device 10 to be able to communicate therewith, in a wired or wireless manner. At least one of the display unit 14 and the input unit 16 may be connected to the learning device 10 via a network or the like. The learning device 10 may include at least one of the display unit 14 and the input unit 16.

The display unit 14 displays various types of information. The display unit 14 is, for example, a display device, a projection device, etc. The input unit 16 receives operation input made by the user. The input unit 16 is, for example, a pointing device, such as a mouse and a touchpad, a keyboard, etc. The display unit 14 and the input unit 16 may be configured as an integrated touch panel. The communication unit 18 is a communication interface to communicate with information processing devices and the like external to the learning device 10.

The learning device 10 is an information processing device learning a learning model. The learning model is a deep neural network (DNN) model obtained by deep learning.

The learning device 10 includes a storage unit 12 and a control unit 20. The storage unit 12 and the control unit 20 are connected to be able to communicate with each other via the bus 19 or the like.

The storage unit 12 stores various types of data. In the present embodiment, the storage unit 12 stores a model management database (DB) 12A. Details of the model management DB 12A will be described later.

The storage unit 12 may be provided outside the learning device 10. The storage unit 12 and one or more functional units included in the control unit 20 may be provided in an external information processing device communicably connected to the learning device 10 via a network or the like.

The control unit 20 executes information processing in the learning device 10. The control unit 20 includes a model generation unit 20A, a performance measurement unit 20D, an accuracy estimation unit 20E, an output control unit 20F, a receiving unit 20G, a training unit 20H, and an accuracy evaluation unit 20I. The model generation unit 20A includes a pruning unit 20B and a morphing unit 20C.

The model generation unit 20A, the pruning unit 20B, the morphing unit 20C, the performance measurement unit 20D, the accuracy estimation unit 20E, the output control unit 20F, the receiving unit 20G, the training unit 20H, and the accuracy evaluation unit 20I are implemented by, for example, one or more processors. For example, each of the above units may be implemented by causing a processor, such as a central processing unit (CPU), to execute a computer program, i.e., by software. Each of the above units may be implemented by a processor, such as a dedicated IC, i.e., hardware. Each of the above units may be implemented using a combination of software and hardware. When plural processors are used, each of the processors may realize one of the units or two or more of the units.

The model generation unit 20A generates learning models 30 with different sizes.

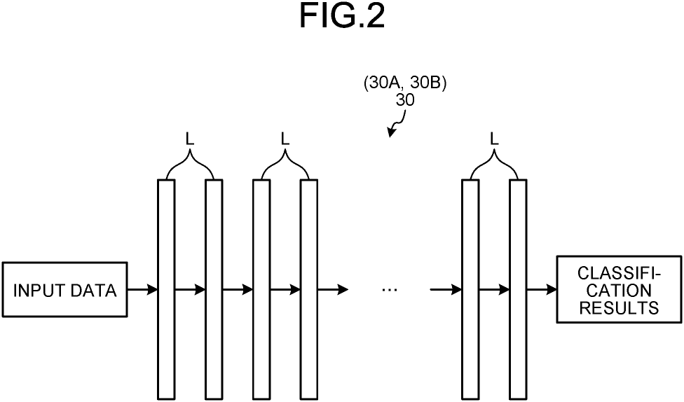

FIG. 2 is an explanatory diagram of an example of a learning model 30. The learning model 30 is a model outputting output results, such as classification results, from input data through a multilayered connection of computations using multiple layers L. Each of the layers L is a convolution layer, a linear layer, an activation layer, a pooling layer, a softmax Layer, etc. In other words, each of the learning models 30 according to the present embodiment is a DNN model formed by multiple layers L including the convolution layer.

The “learning models 30 with different sizes” means that the learning models 30 have different parameter sizes including the size of the convolution filter coefficient of the convolution layer and the weight size of the linear layer. The size of the convolution filter coefficient as the parameter size, that is, the number of convolution filters, is the same as the number of channels of intermediate data output from the convolution layer. The size of the linear layer weight is the product of the number of channels of the input intermediate data and the number of channels of the output intermediate data. For this reason, the expression “the learning models 30 with different sizes” means, in other words, that the number of channels included in the layer L is different.

The model generation unit 20A generates learning models 30 with different sizes by adjusting the parameter size that is the size of the convolution filter coefficient in the convolution layer and the weight size of the linear layer. In other words, the model generation unit 20A generates learning models 30 with different sizes by adjusting the number of channels in the layer L, etc.

The learning models 30 include a trained model 30A and an untrained model 30B. The trained model 30A is a learning model 30 in which trained parameters are incorporated by being trained with a training data set or the like. The untrained model 30B is a learning model 30 on which training with the training data has not been executed.

The model generation unit 20A generates plural untrained models 30B with different sizes by using the trained model 30A.

The model generation unit 20A acquires the trained model 30A from the storage unit 12. The storage unit 12 stores at least one trained model 30A and the model management DB 12A.

The model management DB 12A is a database for managing information relating to the learning models 30. The data format of the model management DB12A is not limited to a database.

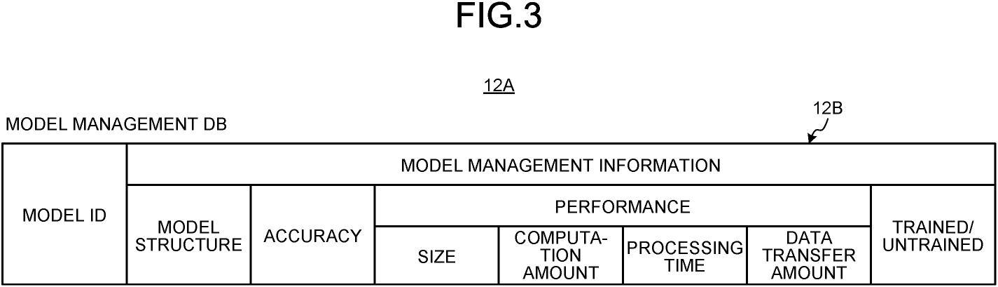

FIG. 3 is a schematic diagram illustrating an example of the data structure of the model management DB 12A. The model management DB 12A is a database associating model IDs (identification information) with pieces of model management information 12B.

The model ID is an identification information used for uniquely identifying the learning model 30.

The model management information 12B is information relating to the learning model 30 identified by the corresponding model ID. The model management information 12B includes items of “model structure”, “accuracy”, “performance”, and a flag indicating that the model is “trained or untrained”.

The item “model structure” is information representing the structure of the learning model 30. The model structure is represented by, for example, the structure of the layer L, the number of channels included in the layer L, the size of the convolution filter coefficient, the number of product-sum operation, etc.

The item “accuracy” is information representing the accuracy of the learning model 30. The accuracy of the learning model 30 is an index indicating a degree of accuracy in outputting correct classification results for input data.

The item “performance” is information representing the performance of the learning model 30. The item “performance” includes more than one parameters. For example, the performance includes parameters, such as the size, the computation amount, the processing time, and the data transfer amount of the learning model 30. The performance may further include other parameters representing the performance of the learning model 30.

The size of the learning model 30 is represented by the number (or size) of convolution filter coefficients included in the learning model 30, as described above. The size of the learning model 30 may be referred to as “parameter size”. As described above, the size of the learning model 30 may be expressed in terms of the number of channels included in the layer L.

The computation amount of the learning model 30 is represented by the number of product-sum operations used in the convolution process. The item “processing time” indicates the computation amount in processing of inference of the learning model 30. The data transfer amount is the amount of data transferred during inference of the learning model 30.

The flag indicating that the model is trained or untrained is a flag indicating that the learning model 30 identified by the corresponding model ID is a trained model 30A having been trained or an untrained model 30B not having been trained.

It is assumed that, when the model generation unit 20A generates an untrained model 30B, the storage unit 12 stores at least one trained model 30A and the model management information 12B corresponding to the model ID of this trained model 30A.

The explanation is continued with reference to FIG. 1 again. The model generation unit 20A uses the trained model 30A to generate plural untrained models 30B with different sizes. The method of generating the untrained models 30B by the model generation unit 20A is not limited. In the present embodiment, pruning and morphing are executed to generate the untrained models 30B with different sizes from one or more trained models 30A.

More specifically, in the present embodiment, the model generation unit 20A includes the pruning unit 20B and the morphing unit 20C.

The pruning unit 20B determines the channel number ratio between the layers L forming the trained model 30A. In other words, the pruning unit 20B determines the channels that are deletion targets and are included in the layer L of the trained model 30A. For example, the pruning unit 20B determines the loosely coupled channels included in the trained model 30A, as channels that are deletion targets. Known methods can be used to identify such loosely coupled channels.

The pruning unit 20B deletes the channels determined to be the deletion targets. By deleting the loosely coupled channels included in the layer L, the pruning unit 20B determines the channel number ratio between the layers L after deletion.

The morphing unit 20C expands or shrinks each layer L in the trained model 30A while maintaining the determined channel number ratio between the layers L.

The process executed by the pruning unit 20B and the morphing unit 20C generates one or more untrained models 30B with different sizes from the trained model 30A.

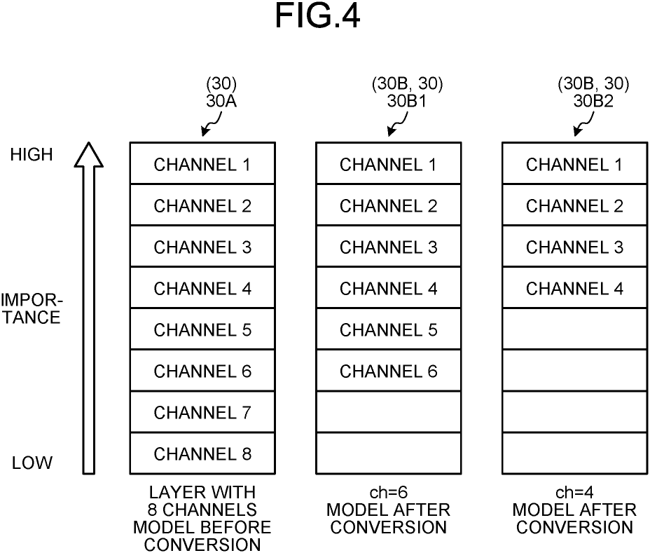

FIG. 4 is an explanatory diagram of an example of generation of untrained models 30B. FIG. 4 illustrates an example of generating an untrained model 30B1 and an untrained model 30B2 as the untrained models 30B from a trained model 30A.

For example, the pruning unit 20B of the model generation unit 20A determines one or more the channels of the layer L of the trained model 30A in the ascending order of importance as the deletion targets, namely, loosely coupled channels. In the trained model 30A, the importance is derived for each of the channels. The model generation unit 20A uses the importance of each of the channels included in the layer L of the trained model 30A to determine one or more channels in the ascending order of importance as deletion targets. Thereafter, the pruning unit 20B deletes the channels determined to be the deletion targets.

In FIG. 4 illustrating the trained model 30A including eight channels 1 to 8 , the untrained model 30B1 with the two channels 8 and 7 deleted in the ascending order of importance, and the untrained model 30B2 with the four channels 8 to 5 deleted in the ascending order of importance are illustrated as an example. The number of channels included in the layer L is not limited to eight. FIG. 4 illustrates an example.

The morphing unit 20C generates the untrained models 30B (untrained models 30B1 and 30B2) by expanding or shrinking the layer L included in the trained model 30A while maintaining the channel number ratio between the layers L determined by deleting the channels.

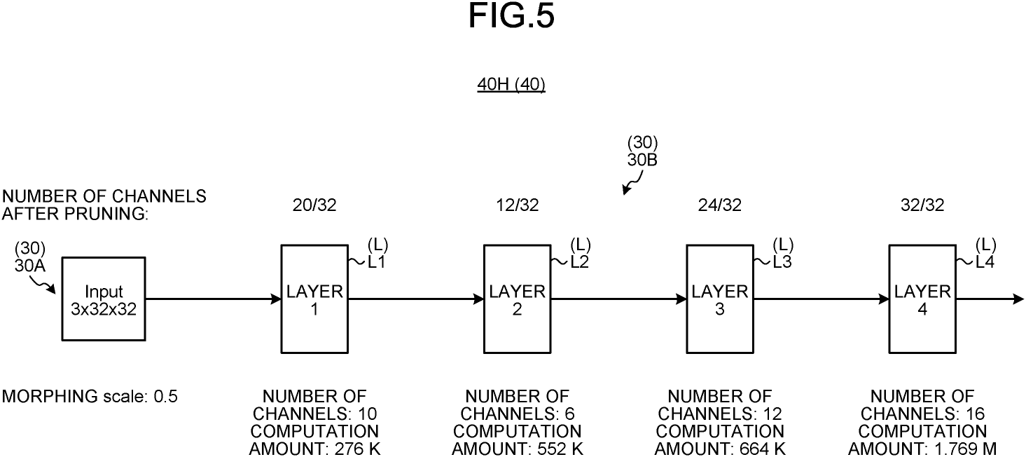

FIG. 5 is an explanatory diagram of an example of generation of untrained models 30B. For example, it is assumed that an untrained model 30B is generated from a trained model 30A with 32 channels on each of layers L1 to L4. For example, it is assumed that the pruning unit 20B of the model generation unit 20A executes pruning to set the number of channels of the layer L1 to 20, the number of channels of the layer L2 to 12, the number of channels of the layer L3 to 24, and the number of channels of the layer L4 to 32. The morphing unit 20C reduces the layers L after pruning to, for example, ½ scale, while maintaining the channel number ratio between the layers L. In this case, the morphing executed by the morphing unit 20C reduces the numbers of channels in the respective layers L1, L2, L3, and L4 to 10, 6, 12, and 16, respectively, to generate the untrained model 30B.

In this manner, in the present embodiment, the model generation unit 20A generates the untrained models 30B with different sizes by pruning by the pruning unit 20B and morphing by the morphing unit 20C. For this reason, the accuracy estimation unit 20E described later can utilize the model after pruning for estimating the accuracy of the untrained model 30B.

Note that the model generation unit 20A may adjust the number of channels of each of the layers L of the generated untrained model 30B to be a value satisfying predetermined setting conditions. The setting conditions may be stored in the storage unit 12 in advance. The setting conditions may be changed as needed by the user’s operation instructions on the input unit 16.

For example, there are cases where the number of channels included in the layer L may need to be adjusted to a multiple of N to cause the learning model 30 to operate fast on the edge device that is the operation target. N is an integer greater than or equal to 2.

The edge device is the hardware on which the learning model 30 is to operate. Edge devices are computers including processors, such as CPUs, field-programmable gate arrays (FPGAs), and application specific integrated circuits (ASICs). For example, the edge device is a processor mounted on a mobile terminal, an in-vehicle terminal, etc. The edge device may also be a processor whose computing performance is at a given performance level or below.

In this case, for example, the user may input setting conditions, such as “the number of channels in a multiple of 4” as the number of channels included in the layer L in advance by operating the input unit 16. When the setting condition is “the number of channels in a multiple of 4”, the model generation unit 20A may adjust the number of channels in each of the layers L of the generated untrained model 30B to be a multiple of 4.

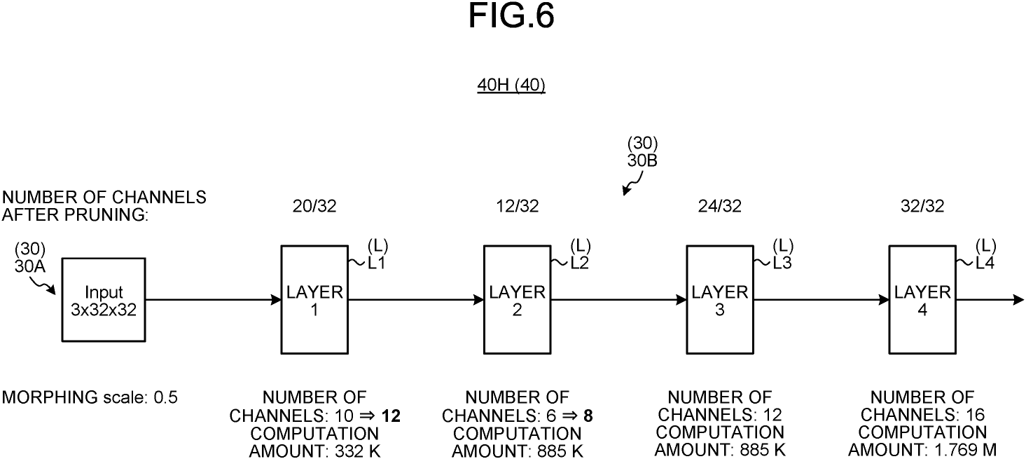

FIG. 6 is an explanatory diagram of an example of adjustment in the case where the setting condition is “number of channels in multiple of 4”. For example, it is assumed that the model generation unit 20A has generated the untrained model 30B illustrated in FIG. 5 by pruning and morphing. In this case, the model generation unit 20A further adjusts the number of channels in each of the layers L to a multiple of 4, as illustrated in FIG. 6. Specifically, for example, the model generation unit 20A adjusts the number of channels for each of the layers L1, L2, L3, and L4 to be 12, 8, 12, and 16, respectively.

In this manner, the model generation unit 20A may adjust the number of channels of the layer L of the generated untrained model 30B to a value satisfying the setting condition. By adjusting the untrained model 30B such that the model generation unit 20A satisfies the setting condition, it is possible to suppress generation of untrained models 30B that are difficult to operate at high speed on the edge device.

The explanation is continued with reference to FIG. 1 again. The performance measurement unit 20D measures the performance of the untrained model 30B generated by the model generation unit 20A. The performance measurement unit 20D may measure the performance of the untrained model 30B using known methods. For example, the performance measurement unit 20D measures the performance of the untrained model 30B by simulating the operation of the untrained model 30B on virtual hardware prepared in advance using known methods.

The accuracy estimation unit 20E estimates the accuracy of the untrained model 30B generated by the model generation unit 20A.

The accuracy estimation unit 20E estimates the accuracy of the untrained model 30B by using the trained model 30A.

For example, the accuracy estimation unit 20E estimates the accuracy of the untrained model 30B by interpolation and extrapolation using the trained models 30A. Specifically, the accuracy estimation unit 20E estimates the accuracy of the untrained model 30B by using the following Expression (1).

$${A}^{′} = \frac{{A}_{1} - {A}_{2}}{{F}_{1} - {F}_{2}} \times \left({F}^{′} - {F}_{1}\right) + {A}_{1}$$

In Expression (1), A′, A₁, and A₂ represent accuracy. Specifically, A′ represents the accuracy of the untrained model 30B that is the accuracy estimation target. A₁ represents the accuracy of a certain trained model 30A1. A₂ represents the accuracy of another trained model 30A2 different from the trained model 30A1 whose accuracy is represented by A₁. The trained model 30A1 and the trained model 30A2 are examples of the trained model 30A.

Further to Expression (1), F′, F₁, and F₂ represent performance. Specifically, F′, F₁, and F₂ each represent any one of the parameters of the computation amount, the processing time, and the data transfer amount. F′ represents the performance of the untrained model 30B that is the accuracy estimation target. F₁ represents the performance of the trained model 30A1. F₂ represents the performance of the trained model 30A2.

The accuracy estimation unit 20E estimates the accuracy of the untrained model 30B using the two trained models 30A and the above Expression (1).

The accuracy estimation unit 20E may estimate the accuracy of the untrained model 30B by averaging the results of interpolation and extrapolation for each of the parameters representing the performance, using the trained models 30A. Specifically, the accuracy estimation unit 20E may estimate the accuracy of the untrained model 30B using the following Expression (2).

$${A}^{′} = \left({\sum }_{f ∈ F} \frac{{A}_{1} - {A}_{2}}{{f}_{1} - {f}_{2}} \times \left({f}^{′} - {f}_{1}\right) + {A}_{1}\right) \div \# F$$

In Expression (2), A′, A₁, and _{A2} are the same as in Expression (1) above. In Expression (2), F′, F₁, and F₂ represent all of the parameters representing the performance. Specifically, F′ represents all of the parameters representing the performance of the untrained model 30B that is the accuracy estimation target. F₁ represents all of the parameters representing the performance of the trained model 30A₁. F₂ represents all of the parameters representing the performance of the trained model 30A₂. The symbol “#” represents the number of parameters representing the performance.

Further to Expression (2), f represents one of the parameters representing the performance. Specifically, f′, f₁, and f₂ each represent the parameters for the computation amount, the processing time, and the data transfer amount. f′ represents one of the parameters representing the performance of the untrained model 30B that is the accuracy estimation target. f₁ represents one of the parameters representing the performance of the trained model 30A1. f₂ represents one of the parameters representing the performance of the trained model 30A2.

Note that the accuracy estimation unit 20E may estimate the accuracy of the untrained model 30B from one trained model 30A.

An explanation will be made with reference to FIG. 4. The accuracy estimation unit 20E estimates the accuracy of the untrained model 30B that is the accuracy estimation target generated by deletion of channels included in the trained model 30A. The accuracy is estimated on the basis of: the accuracy of the trained model 30A, the importance of each of the channels in the layer L of the trained model 30A, and the importance of each of the channels included in the layer L of the untrained model 30B.

Specifically, for example, it is assumed that the model generation unit 20A generates the untrained model 30B1 acquired by deleting the two channels 8 and 7 in the ascending order of importance in the eight channels 1 to 8 included in the layer L of the trained model 30A. In this case, the accuracy estimation unit 20E estimates the accuracy of the untrained model 30B1 by multiplying the ratio of the sum of the weighted values according to the importance of each of the channels 1 to 6 to the sum of the weighted values according to the importance of each of the channels 1 to 8 of the trained model 30A by the accuracy of the trained model 30A.

For another example, it is assumed that the model generation unit 20A generates the untrained model 30B2 acquired by deleting the four channels 8 to 5 in the ascending order of importance in the eight channels 1 to 8 included in the layer L of the trained model 30A. In this case, the accuracy estimation unit 20E estimates the accuracy of the untrained model 30B2 by multiplying the ratio of the sum of the weighted values according to the importance of each of the channels 1 to 4 to the sum of the weighted values according to the importance of each of the channels 1 to 8 of the trained model 30A by the accuracy of the trained model 30A.

In this manner, the accuracy estimation unit 20E estimates the accuracy of the untrained model 30B from one or more trained models 30A. With this configuration, the accuracy estimation unit 20E can estimate the accuracy of the untrained model 30B without training the untrained model 30B.

The explanation is continued with reference to FIG. 1 again. The accuracy estimation unit 20E may select any trained model 30A as the trained model 30A used for accuracy estimation of the untrained model 30B.

The accuracy estimation unit 20E preferably estimates the accuracy of the untrained model 30B using one or more trained models 30A each having a size difference equal to or smaller than a threshold value from that of the untrained model 30B that is the accuracy estimation target, in the trained models 30A stored in the storage unit 12. The threshold value may be determined in advance. The threshold value may be changed as needed by the user’s operation instructions on the input unit 16.

The accuracy estimation unit 20E may select the trained model 30A closest in size to the untrained model 30B that is the accuracy estimation target, as the trained model 30A used for accuracy estimation, from the trained models 30A stored in the storage unit 12. When estimating the accuracy of the untrained model 30B by using the trained models 30A, the accuracy estimation unit 20E may select more than one trained models 30A in the order of closer size, as the trained models 30A used for accuracy estimation from the trained models 30A stored in the storage unit 12.

In the trained models 30A generated by resizing by the control unit 20 and training described later, it is preferable for the accuracy estimation unit 20E to exclude a trained model 30A whose change amount to the performance before resizing is equal to or smaller than a threshold value from the trained models 30A used for accuracy estimation of the untrained models 30B. The threshold value may be determined in advance. The threshold value may also be changeable by the user’s operation instructions on the input unit 16.

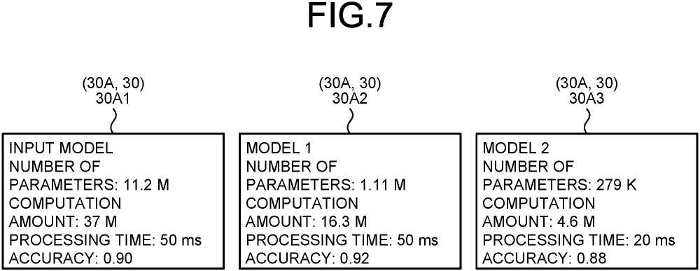

FIG. 7 is an explanatory diagram of an example of a plurality of trained models 30A generated by the resizing by the control unit 20 and the training described later. FIG. 7 illustrates, as an example, a trained model 30A1 before resizing, and trained models 30A2 and 30A3 generated by resizing the trained model 30A1 and training the resulting model.

For example, it is assumed that the trained model 30A2 and the trained model 30A3 are generated from the trained model 30A1 by resizing by the control unit 20 and the training as described later. Then, it is assumed that the accuracy estimation unit 20E estimates the accuracy of the untrained model 30B newly generated by the model generation unit 20A. In this case, the accuracy estimation unit 20E excludes the trained model 30A2 in which the change amount in processing time that is one of the parameters included in the performance is less than a threshold value from the trained models 30A used to estimate the accuracy of the untrained model 30B. In the example illustrated in FIG. 7, the accuracy estimation unit 20E can exclude the trained model 30A2 with a smaller decrease in processing time, while the computation amount and the number of parameters thereof are reduced, from the accuracy estimation target of the untrained model 30B.

The accuracy estimation unit 20E may thereafter estimate the accuracy of the untrained model 30B by using the trained model 30A1 and the trained model 30A3 along with above-described Expression (1) or Expression (2), etc.

The accuracy of the untrained model 30B can be estimated with high accuracy by causing the accuracy estimation unit 20E to exclude the trained model 30A whose change amount to the performance before resizing is less than the threshold value from the trained models 30A used to estimate the accuracy of the untrained model 30B.

The explanation is continued with reference to FIG. 1 again. The accuracy estimation unit 20E stores the untrained model 30B generated by the model generation unit 20A in the storage unit 12. The accuracy estimation unit 20E also registers, in the model management DB 12A, the model management information 12B of the untrained model 30B generated by the model generation unit 20A.

An explanation will be made with reference to FIG. 3. Specifically, the accuracy estimation unit 20E assigns a model ID to the untrained model 30B and registers the model management information 12B of the untrained model 30B in the model management DB 12A in association with the model ID. The accuracy estimation unit 20E may register the model management information 12B in the model management DB 12A. The model management information 12B includes the model structure of the trained model 30A generated by the model generation unit 20A, the performance measured by the performance measurement unit 20D, the accuracy estimated by the accuracy estimation unit 20E, and a flag indicating that the model has not been trained.

Therefore, the trained model 30A and the generated untrained models 30B with different sizes are stored in the storage unit 12. In addition, the model management information 12B for each of the trained model 30A and the generated untrained models 30B is registered in the model management DB 12A.

The explanation is continued with reference to FIG. 1 again. The output control unit 20F outputs model information for each of the learning models 30 with different sizes. The expression “output of model information” means at least one of the following: display, sound output, storage, and transmission of the model information to an external information processing device. The present embodiment illustrates a mode in which the output control unit 20F displays model information for each of the learning models 30 on the display unit 14, as an example.

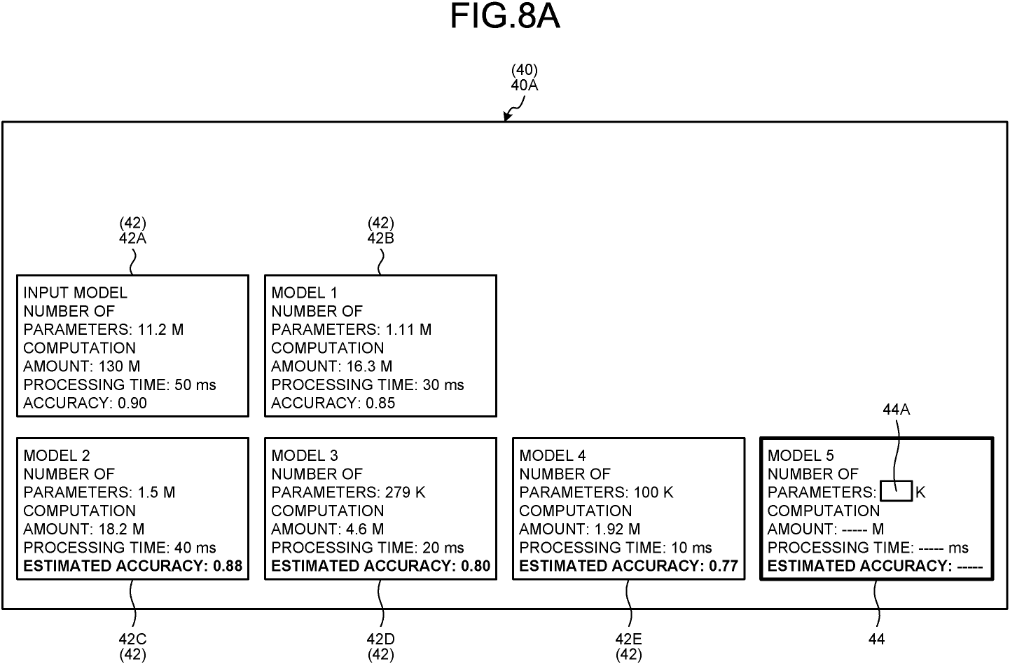

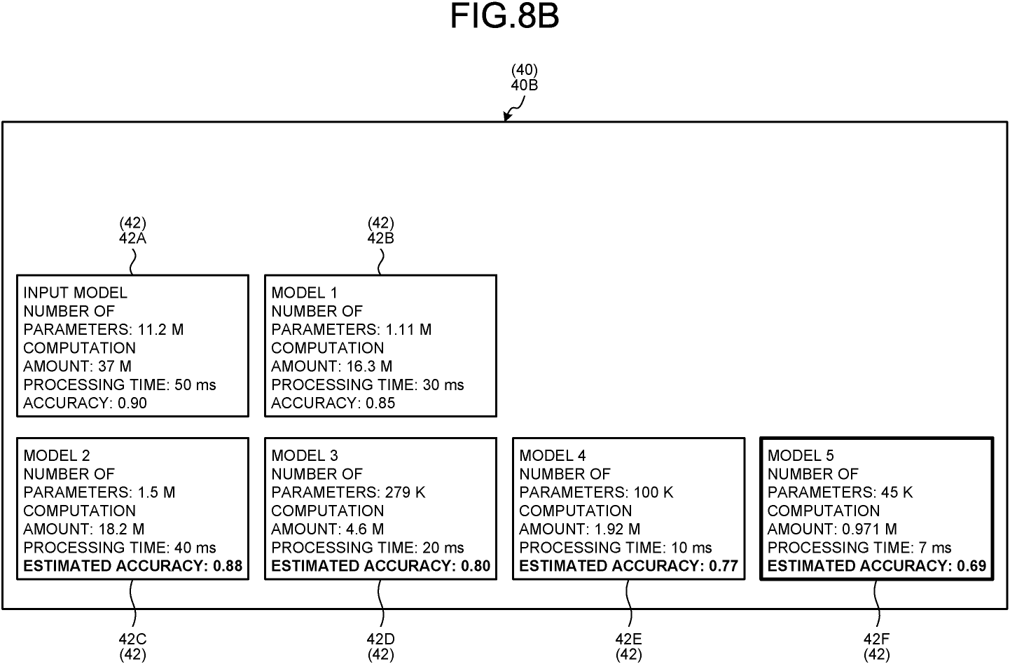

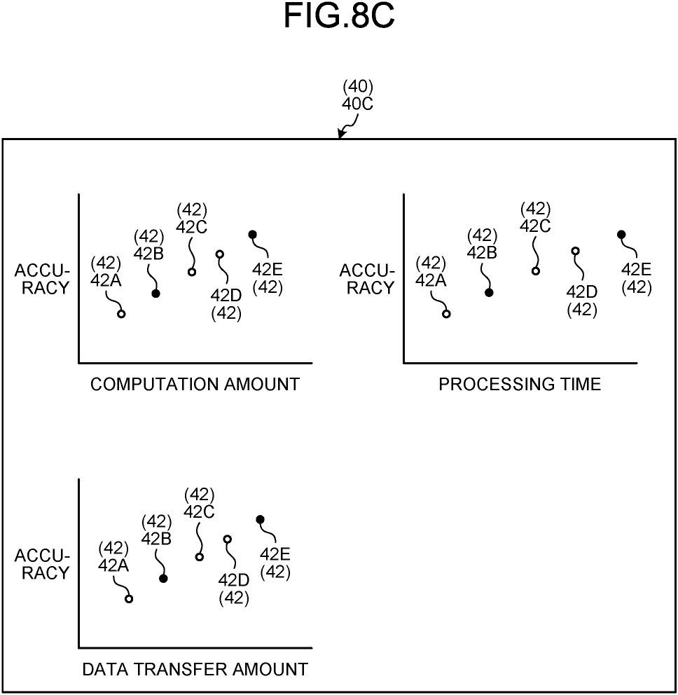

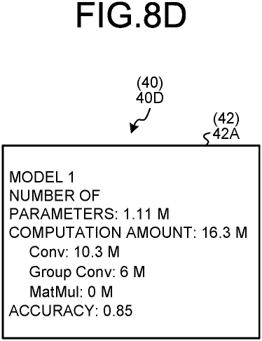

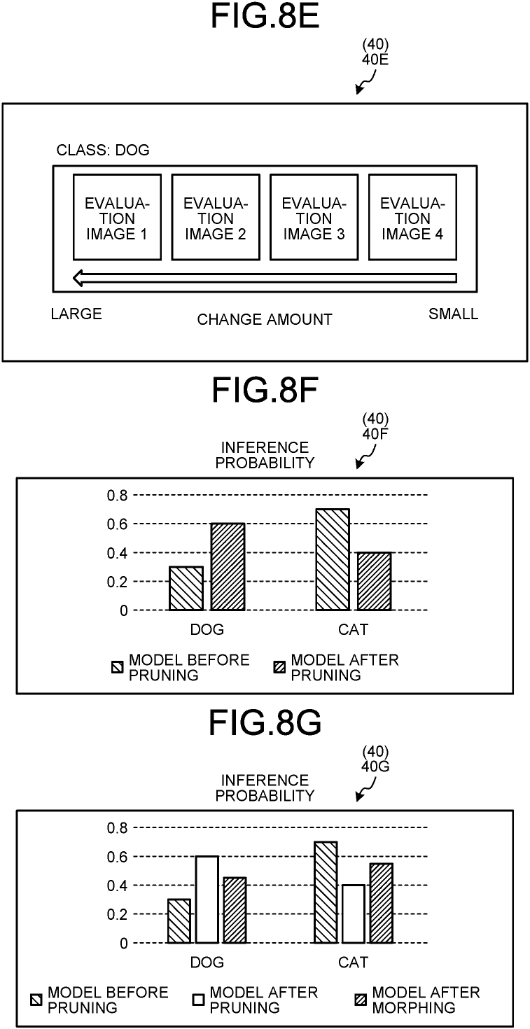

FIG. 8A is a schematic diagram of an example of a display screen 40A. The display screen 40A is an example of a display screen 40 displayed on the display unit 14. The output control unit 20F displays the display screen 40 including pieces of model information 42 on the display unit 14. Specifically, the output control unit 20F displays the model information 42 for each of the learning models 30 including the trained models 30A and the untrained models 30B on the display unit 14.

The model information 42 is information including the accuracy and the performance of each of the learning models 30. The output control unit 20F reads each of the pieces of model management information 12B registered in the model management DB 12A, and displays, on the display unit 14, the display screen 40A of the model information 42 including each of the pieces of the model management information 12B. That is, the output control unit 20F outputs the model information 42 including the accuracy and the performance of the trained model 30A and the model information 42 including the estimated accuracy and performance of the untrained model 30B.

For example, the output control unit 20F displays, on the display screen 40, a list of character information representing each of the pieces of the model information 42.

FIG. 8A illustrates, as an example, the display screen 40A including model information 42 including model information 42A to model information 42E. When the flag included in the model management information 12B indicates that the model has not been trained, the output control unit 20F displays, on the display screen 40A, the model information 42 with the accuracy included in the model management information 12B as “estimated accuracy”. When the flag included in the model management information 12B indicates that the model has been trained, the output control unit 20F displays, on the display screen 40A, the model information 42 with the accuracy included in the model management information 12B as simply “accuracy”. With this configuration, by checking whether the accuracy included in the model information 42 in the display screen 40 is “accuracy” or “estimated accuracy,” the user can check whether the learning model 30 represented by the model information 42 is a trained model 30A or an untrained model 30B.

The user selects the model information 42 of the desired accuracy and performance from the pieces of model information 42 included in the display screen 40 by operating the input unit 16 while viewing the display unit 14. For example, the user selects the desired model information 42 from the pieces of model information 42 included in the display screen 40 and operates a training execution button. With this selection and manipulation, the user selects the model information 42 with the desired accuracy and desired performance. By causing the output control unit 20F to display the pieces of model information 42, the user can select the model information 42 while checking the displayed performance and accuracy. This structure enables the user to easily select the model information 42 of the learning model 30 with the desired performance and accuracy.

The explanation is continued with reference to FIG. 1 again. The receiving unit 20G receives input made by the user. When one of the pieces of model information 42 included in the display screen 40 is selected by the user’s operation instruction on the input unit 16 and the training execution button is operated, the receiving unit 20G receives the input of the selected model information 42 and a training execution instruction. The training execution button is a predefined display area provided on the display screen 40. For example, the user may operate the training execution button by operating the image area of the training execution button included in the display screen 40.

The training unit 20H trains the learning model 30 represented by the model information 42 selected by the user from the displayed pieces of model information 42. Specifically, the training unit 20H trains the learning model 30 represented by the model information 42 received by the receiving unit 20G together with a training execution instruction signal representing the training execution instruction.

When the learning model 30 represented by the selected model information 42 is an untrained model 30B, the training unit 20H trains the untrained model 30B using the training data set stored in advance. For example, the training unit 20H stores pieces of training data formed of input data and correct classification results as a training data set in the storage unit 12 in advance. The training unit 20H thereafter generates a trained model 30A from the untrained model 30B by training the untrained model 30B by a known method using the selected untrained model 30B and the training data set.

The accuracy evaluation unit 20I evaluates the accuracy of the trained model 30A trained by the training unit 20H. The accuracy evaluation unit 20I may evaluate the accuracy of the trained model 30A using a known method. The accuracy evaluation unit 20I stores the trained model 30A trained by the training unit 20H in the storage unit 12. The accuracy evaluation unit 20I also registers the model management information 12B of the trained model 30A trained by the training unit 20H in the model management DB 12A.

An explanation will be made with reference to FIG. 3. Specifically, the accuracy evaluation unit 20I registers the model management information 12B of the trained model 30A in the model management DB 12A in association with the model ID of the untrained model 30B being the learning model 30 before training of the trained model 30A that has been trained. The accuracy evaluation unit 20I overwrites the accuracy being the estimated accuracy estimated by the accuracy estimation unit 20E with the accuracy evaluated by the accuracy evaluation unit 201. In addition, the accuracy evaluation unit 20I updates the flag corresponding to the model ID and indicating that the model has not been trained to the flag indicating that the model has been trained. Through these processes, the accuracy evaluation unit 20I registers the model management information 12B of the trained model 30A in the model management DB 12A.

With this configuration, the model management information 12B of the untrained model 30B registered in the model management DB 12A is updated to the model management information 12B of the trained model 30A generated by training of the untrained model 30B.

There are the cases where the model information 42 displayed on the display screen 40 does not include the model information 42 of the performance desired by the user. In this case, the user inputs the desired performance by operating the input unit 16. The receiving unit 20G receives the desired performance input by the user.

An explanation will be made with reference to FIG. 8A. For example, the display screen 40A includes a setting field 44. The setting field 44 is a setting field for receiving model performance input. FIG. 8A illustrates the setting field 44, as an example, including an input field 44A for the number of parameters that is the size of the model, among the parameters included in the performance of the model. The output control unit 20F may display the display screen 40 including the setting field 44 on the display unit 14. The setting field 44 may be a setting field for receiving the input of parameters included in the performance of the model, and may be able to receive the input of at least one parameter representing performance, such as the number of parameters, the computation amount, and the processing time.

When the performance desired by the user is input via the display screen 40, the model generation unit 20A may generate an untrained model 30B of the performance for which the input has been received. The model generation unit 20A may generate the untrained model 30B in the same manner as above using the trained model 30A on the basis of the information representing the performance for which the input has been received.

For example, it is assumed that the user has input the desired number of parameters to the input field 44A by operating the input unit 16. In this case, the model generation unit 20A may generate the untrained model 30B of the number of parameters for which input has been received, i.e., of the size desired by the user. Specifically, the morphing unit 20C of the model generation unit 20A generates the untrained model 30B of the size desired by the user by expanding or shrinking the layer L included in the trained model 30A to the size having been input.

The performance measurement unit 20D and the accuracy estimation unit 20E thereafter execute the same process as above for the generated untrained model 30B. With this configuration, the storage unit 12 stores the untrained model 30B of the performance input by the user. In addition, the model management information 12B of the untrained model 30B of the performance input by the user is registered in the model management DB 12A.

When the model management information 12B is updated, the output control unit 20F displays, on the display unit 14, the display screen 40 including the model information 42 for each of the pieces of model management information 12B registered in the model management DB 12A.

For example, by inputting the performance desired by the user, such as the number of parameters, to the input field 44A illustrated in FIG. 8A, a display screen 40B further including model information 42F of the untrained model 30B with the performance desired by the user is displayed on the display unit 14, as illustrated in FIG. 8B. The display screen 40B is an example of the display screen 40. This structure enables the user to easily and flexibly select the model information 42 of the learning model 30 with the desired performance and accuracy.

The output control unit 20F may display the pieces of model information 42 in a graph format.

FIG. 8C is a schematic diagram of an example of a display screen 40C of the model information 42. The display screen 40C is an example of the display screen 40.

For example, the output control unit 20F displays a graph illustrating the relation between the accuracy and the performance in each of the pieces of model information 42. FIG. 8C illustrates an example of the form in which each of the pieces of the model information 42A to 42E is represented by a graph illustrating the relation between the accuracy and the computation amount, a graph illustrating the relation between the accuracy and the processing time, and a graph illustrating the relation between the accuracy and the data transfer amount. As illustrated in FIG. 8C, the output control unit 20F may display graphs representing the relation between the accuracy and the performance in each of the pieces of model information 42.

The output control unit 20F displays pieces of the model information 42 in a graph format, enabling the user to intuitively select the model information 42 with the desired performance and accuracy.

The output control unit 20F may display the model information 42 of the trained model 30A and the model information 42 of the untrained model 30B in different display forms. For example, the output control unit 20F may display, on the display screen 40, a graph illustrating the plot of the model information 42 of the trained model 30A and the plot of the model information 42 of the untrained model 30B in different colors.

By displaying the model information 42 of the trained model 30A and the model information 42 of the untrained model 30B in different forms, the user can easily check whether the displayed accuracy is the estimated accuracy.

The output control unit 20F may also display each parameter included in the performance by type of computation.

FIG. 8D is a schematic diagram of an example of a display screen 40D. The display screen 40D is an example of the display screen 40. FIG. 8D illustrates one piece of the model information 42 included in the display screen 40D, as an example. As illustrated in FIG. 8D, the output control unit 20F may display the computation amount that is the performance included in the model information 42 for each type of computation. The output control unit 20F may also display other parameters included in the performance for each type of computation, when there are plural types of computation.

The output control unit 20F displays each parameter included in the performance for each type of computation. With this configuration, it is possible to easily provide the computation amount for each type of computation with different computation efficiency. This structure enables the user to more easily select the model information 42 of the learning models 30 with the desired performance.

The output control unit 20F may further output detailed information on the model information 42.

An explanation will be made with reference to FIG. 8A. For example, by operating the input unit 16 while viewing the display unit 14, the user selects the model information 42 that the user wants to check in detail among the pieces of model information 42 included in the display screen 40, and operates a detail check button. The detail check button is a predefined display area provided on the display screen 40. For example, the user may operate the detail check button by operating the image area of the detail check button included in the display screen 40.

When the model information 42 is selected and the detail check button is operated, the receiving unit 20G receives the model information 42 and a detail display signal for the model information 42. When the output control unit 20F receives the detail display signal, the output control unit 20F displays detailed information on the selected model information 42 on the display unit 14.

For example, it is assumed here that the model information 42C in FIG. 8A is selected and the detail check button is operated.

In this case, for example, the output control unit 20F displays, on the display unit 14, the number of channels and the performance of each of the layers L of the learning model 30 defined by the selected model information 42C.

For example, the output control unit 20F displays a display screen 40H illustrated in FIG. 5 on the display unit 14. The output control unit 20F reads the model management information 12B corresponding to the model ID of the selected model information 42C from the model management DB 12A. The output control unit 20F thereafter displays the model structure, the accuracy, and the performance included in the read model management information 12B on the display screen 40H. FIG. 5 illustrates an example of the display screen 40H including the number of channels and the computation amount for each of the layers L, that is, the layer L1 to the layer L4, of the learning model 30 represented by the selected model information 42C.

In this manner, the output control unit 20F may display, as the detailed information on the model information 42, the number of channels and the performance of each of the layers L of the learning model 30 represented by the model information 42.

The output control unit 20F displays detailed information on the model information 42, enabling the user to easily and flexibly select the desired model information 42.

The user may wish to change the model information 42 displayed on the display screen 40H. In this case, the user changes, by operating the input unit 16, at least one of the parameters included in the model structure and the performance included in the desired model information 42. The receiving unit 20G receives the changed model information 42 input by the user.

For example, the user changes the channel number ratio between the layers L represented by the model structure by operating the input unit 16. For example, while viewing the display screen 40H illustrated in FIG. 5, the user changes the channel number ratio between the displayed layers L by changing the number of at least some of channels in the layers L. The receiving unit 20G receives the model information 42 input by the user with the changed number of channels included in the layer L.

In this case, the model generation unit 20A may generate the untrained model 30B defined by the changed model information 42. The performance measurement unit 20D and the accuracy estimation unit 20E thereafter execute the same process as above for the generated untrained model 30B. In other words, the accuracy estimation unit 20E estimates again the accuracy of the learning model 30 according to the changed model information 42 and registers it in the model management DB 12A.

With this configuration, an untrained model 30B with the performance or the model structure changed by the user is stored in the storage unit 12. In addition, the model management information 12B of an untrained model 30B with the performance or the model structure having been changed by the user is registered in the model management DB 12A.

The output control unit 20F displays detailed information on the model information 42 and receives fine-tuning of the channel number ratio made by the user, enabling the user to easily and flexibly select the desired model information 42.

The explanation is continued with reference to FIG. 1 again. The output control unit 20F may output the change amount in inference results before and after the size change, for the evaluation data and the evaluation data for each of the learning models 30.

In other words, the output control unit 20F may output the change amount in inference results between the inference results for the evaluation data by the learning model 30 before resizing and the inference results for the evaluation data by the learning model 30 after resizing, and the evaluation data.

The evaluation data is, for example, input data included in the training data used in training of the learning model 30. The evaluation data is not limited to the input data included in the training data used in training. For example, the evaluation data may be data with correct answers that have not been used for training. The data with correct answers is, for example, validation data.

For example, the output control unit 20F reads the input data included in each of the pieces of the training data included in the training data set used in training of the trained model 30A. By this process, the output control unit 20F is enabled to read the pieces of input data. For example, the following example illustrates a form in which the input data is image data including a subject. In the following description, the image data may be referred to as “evaluation image”.

For each of the read evaluation images, the output control unit 20F derives each of the inference results of the evaluation image using the trained model 30A before pruning and the inference results of the evaluation image using the trained model 30A after pruning.

The inference result is represented by the inference probability for each of classes being types of the subject included in the evaluation image. That is, for each of the evaluation images, the output control unit 20F derives, for each of the classes, the inference result of the evaluation image using the trained model 30A before pruning and the inference result of the evaluation image using the trained model 30A after pruning. The output control unit 20F may derive the inference result for each of the classes by obtaining these inference results from the training unit 20H.

For the learning model 30 represented by the model information 42 selected by the user, the output control unit 20F may derive the inference results of the evaluation image using the untrained model 30B before pruning and using the untrained model 30B after pruning.

For example, it is assumed here that the model information 42D is selected via the display screen 40A illustrated in FIG. 8A and the detail check button is operated.

In this case, for example, the output control unit 20F displays, on the display unit 14, the display screen 40 including the evaluation images used for training of the learning model 30 defined by the selected model information 42A.

FIG. 8E is a schematic diagram of an example of a display screen 40E. The display screen 40E is an example of the display screen 40. For example, the output control unit 20F displays the display screen 40E acquired by arranging a predetermined number of evaluation images in the descending order of the change amount being the difference between the inference results of the evaluation image using the untrained model 30B before pruning and the inference results of the evaluation image using the untrained model 30B after pruning. FIG. 8E illustrates, as an example, the case where the evaluation image is an image of an animal, such as a dog. FIG. 8E illustrates an example of displaying four evaluation images for the class “dog”, which is an example of a class, in the descending order of the change amount in evaluation results.

For example, it is assumed that the user selects one of the displayed evaluation images by operating the input unit 16. In this case, the receiving unit 20G receives the selection of the evaluation image. The output control unit 20F displays the inference results of the evaluation image using the trained model 30A before pruning and the inference results of the evaluation image using the trained model 30A after pruning for the evaluation image for which the selection has been received. For example, the explanation is continued on the supposition that an evaluation image 1 is selected.

FIG. 8F is a schematic diagram illustrating an example of a display screen 40F illustrating the inference results of the evaluation image before and after pruning. The display screen 40F is an example of the display screen 40. For example, for each of the classes, such as a class “dog” and a class “cat,” the output control unit 20F displays the inference probability being an example of the inference result with the learning model 30 before pruning, and the inference probability being an example of the inference result with the learning model 30 after pruning.

In this case, the output control unit 20F can provide the user, in an easy way to understand, with what input data inference results are likely to change due to pruning.

The output control unit 20F may also display the inference results of the evaluation image using the trained model 30A before pruning, the inference results of the evaluation image using the trained model 30A after pruning, and the inference results of the evaluation image using the untrained model 30B after morphing. For example, the output control unit 20F estimates the probability of the inference result of the evaluation image using the untrained model 30B after morphing by interpolation and extrapolation from the difference in performance parameters using the trained models 30A, in the same manner as the estimation of accuracy by the accuracy estimation unit 20E. For example, the output control unit 20F may create a pseudo resized model with a reduced number of channels by inferring the less important channels of one trained model 30A by filling them with 0, and then determine the inference result of the inference as the inference result of the evaluation image using the untrained model 30B after morphing. The explanation is continued on the assumption that the evaluation image 1 is selected.

FIG. 8G is a schematic diagram illustrating an example of a display screen 40G illustrating the inference results of the evaluation image before and after pruning and after morphing. The display screen 40G is an example of the display screen 40. For example, for each of the classes, such as the class “dog” and the class “cat,” the output control unit 20F displays the inference probability being an example of the inference result using the learning model 30 before pruning, the inference probability being an example of the inference result using the learning model 30 after pruning, and the inference probability being an example of the inference result using the learning model 30 after morphing.

In this case, the output control unit 20F can provide the user, in an easy way to understand, with what input data inference results are likely to change due to pruning and morphing. In addition, the output control unit 20F can easily provide the inference results of the untrained model 30B being the untrained model.

The following is an explanation of an example of flow of the information processing executed by the learning device 10 according to the present embodiment.

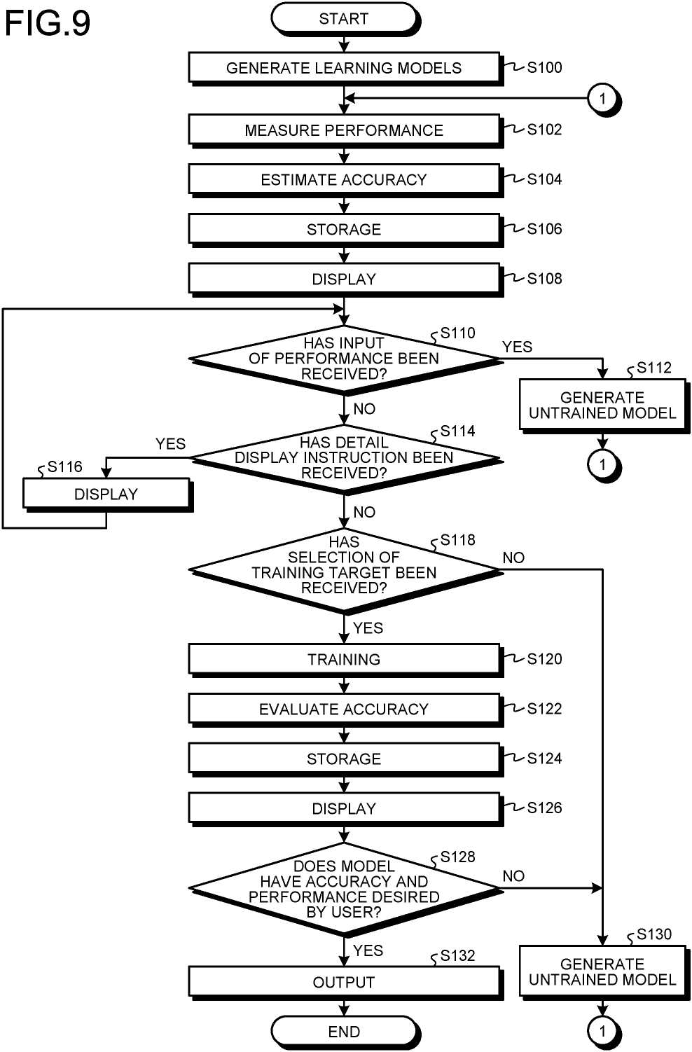

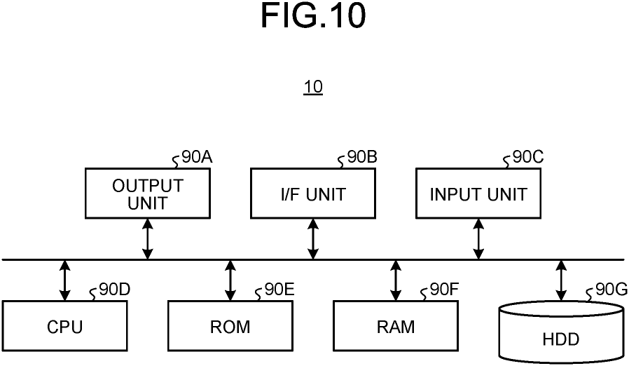

FIG. 9 is a flowchart illustrating an example of the flow of information processing executed by the learning device 10 according to the present embodiment.

The model generation unit 20A generates learning models 30 with different sizes (Step S100). The model generation unit 20A generates one or more untrained models 30B with different sizes using the trained model 30A (Step S100).

The performance measurement unit 20D measures the performance of the untrained model 30B generated by the model generation unit 20A (Step S102). The accuracy estimation unit 20E estimates the accuracy of the untrained model 30B whose performance has been measured at Step S102 (Step S104). The accuracy estimation unit 20E stores the untrained model 30B with estimated performance and the model management information 12B of the pruning unit 20B in the storage unit 12 (Step S106).

The output control unit 20F displays the model information 42 for each of the learning models 30 with different sizes on the display unit 14 (Step S108). For example, the output control unit 20F displays the display screen 40A illustrated in FIG. 8A on the display unit 14.

The receiving unit 20G determines whether the input of the performance desired by the user has been received (Step S110). For example, there are cases where the model information 42 displayed on the display screen 40 includes no model information 42 of the performance desired by the user. In this case, the user inputs the desired performance by operating the input unit 16. The receiving unit 20G receives the desired performance input by the user.

When the input of the performance desired by the user is received (Yes at Step S110), the process proceeds to Step S112. At Step S112, the model generation unit 20A generates an untrained model 30B of the performance for which input has been received at Step S110 (Step S112). Thereafter, the process returns to Step S102 above.

When a negative determination is made at Step S110 (No at Step S110), the process proceeds to Step S114. At Step S114, the receiving unit 20G determines whether a detail display instruction has been received (Step S114). For example, by operating the input unit 16 while viewing the display unit 14, the user selects the model information 42 that the user wants to check in detail among the pieces of model information 42 included in the display screen 40, and operates the detail check button. When the model information 42 is selected and the detail check button is operated, the receiving unit 20G receives the model information 42 and a detail display signal for the model information 42. The receiving unit 20G may determine whether a detail display instruction has been received by determining whether the model information 42 and the detail display signal for the model information 42 have been received.

If the detailed display instruction has been received (Yes at Step S114), the process proceeds to Step S116. At Step S116, the output control unit 20F displays detailed information on the selected model information 42 on the display unit 14 (Step S116). For example, as illustrated in FIG. 5, the output control unit 20F displays, on the display unit 14, the display screen 40 including the number of channels and performance of each of the layers L of the learning model 30 defined by the selected model information 42. For example, the output control unit 20F displays the display screen 40, as illustrated in FIG. 8E to FIG. 8G, on the display unit 14 in response to the user’s operation instructions on the input unit 16. Thereafter, the process returns to Step S110 above.

When a negative determination is made at Step S114 (No at Step S114), the process proceeds to Step S118. At Step S118, the receiving unit 20G determines whether the selection of the model information 42 of a training target has been received (Step S118). For example, the user selects the model information 42 with the desired accuracy and performance from the pieces of model information 42 included in the display screen 40 by operating the input unit 16 while viewing the display unit 14, and thereafter operates the training execution button. The receiving unit 20G may determine whether the selection of the model information 42 of a training target has been received by determining whether the selected model information 42 and a training execution instruction signal representing the training execution instruction have been received.

When a positive determination is made at Step S118 (Yes at Step S118), the process proceeds to Step S120. At Step S120, the training unit 20H trains the learning model 30 represented by the model information 42 whose selection has been received at Step S118 (Step S120).

The accuracy evaluation unit 20I evaluates the accuracy of the trained model 30A generated by the training at Step S120 (Step S122). Thereafter, the accuracy evaluation unit 20I stores the trained model 30A generated by the training at Step S120 and the model management information 12B of the trained model 30A in the storage unit 12 (Step S124).

The output control unit 20F displays the model information 42 of the trained model 30A stored in the storage unit 12 at Step S124 on the display unit 14 (Step S126).

The output control unit 20F determines whether the trained model 30A of the model information 42 displayed at Step S126 is the model with the accuracy and the performance desired by the user (Step S128).

For example, by viewing the model information 42 displayed at Step S126, the user determines whether the learning model 30 represented by the model information 42 has the desired performance and accuracy. When the desired performance and accuracy are achieved, the user thereafter inputs information indicating that the model is the desired learning model 30 by operating the input unit 16. By contrast, when the performance and accuracy are not desired ones, the user inputs information indicating that the model is not the desired learning model 30 by operating the input unit 16. The output control unit 20F makes a negative determination (No at Step S128) when the receiving unit 20G receives information indicating that the performance and accuracy are not desired ones. Thereafter, the process proceeds to Step S130.

At Step S130, the model generation unit 20A generates a new untrained model 30B of a size different from the size of the learning model 30 stored in the storage unit 12 (Step S130). Thereafter, the process returns to Step S102 above.

By contrast, the output control unit 20F makes a positive determination (Yes at Step S128) when the receiving unit 20G receives the information indicating that the performance and accuracy are desired ones. Thereafter, the process proceeds to Step S132. At Step S132, the output control unit 20F outputs the learning model 30 trained at Step S120 (Step S132). For example, the output control unit 20F transmits the learning model 30 trained at Step S120 to the information processing device managed by the user. The output control unit 20F stores the learning model 30 trained at Step S120 in the storage unit 12 as the determined model. The output control unit 20F may also display the model information 42 of the learning model 30 trained at Step S120 on the display unit 14 as the determined model. The routine is thereafter finished.

As explained above, the learning device 10 according to the present embodiment includes the output control unit 20F, the receiving unit 20G, and the training unit 20H. The output control unit 20F outputs pieces of the model information 42 each including accuracy and performance for each of the learning models 30 with different sizes. The receiving unit 20G receives input made by the user. The training unit 20H trains the learning model 30 represented by the model information 42 selected by the user from the pieces of model information 42.

Meanwhile, in the conventional technique, the user is required to specify parameters relating to various performances, such as the computation amount, the processing time, the power consumption, the size, and the data transfer amount, to provide a trained model (30A) with the accuracy and performance desired by the user. For example, reducing the size of the trained model (30A) according to the edge device may reduce the accuracy of the trained model (30A). For this reason, in the conventional technique, the user is required to set various parameters relating to performance, such as the computation amount, the processing time, the power consumption, the data transfer amount, and the size, such that the desired accuracy is achieved. In addition, the conventional technique requires training for each of the models to derive the accuracy of the model. This structure requires a high processing load. In other words, it is difficult for conventional techniques to easily provide trained models with accuracy and performance desired by the user.

By contrast, the learning device 10 according to the present embodiment outputs the model information 42 for each of the learning models 30 with different sizes, and trains the learning model 30 represented by the model information 42 selected by the user.

This structure enables the user to select the model information 42 of the desired learning model 30 by selecting the model information 42 of the desired performance and accuracy from the output pieces of model information 42. The trained model 30A can be generated by training the learning model 30 represented by the model information 42 selected by the user. Because the selected learning model 30 is trained without training all the untrained models 30B with different sizes, the learning device 10 in the present embodiment can learn the learning model 30 efficiently.

Accordingly, the learning device 10 according to the present embodiment can easily provide a trained model 30A with the accuracy and performance desired by the user.

The following is an explanation of an example of the hardware configuration of the learning device 10 according to the embodiment described above.

FIG. 10 is a hardware configuration diagram of an example of the learning device 10 according to the embodiment described above.

The learning device 10 according to the embodiment described above includes a control unit, such as a central processing unit (CPU) 90D, a storage device, such as a read-only memory (ROM) 90E, a random-access memory (RAM) 90F, and a hard disk drive (HDD) 90G, an I/F unit 90B serving as an interface with various devices, an output unit 90A outputting various types of information, an input unit 90C receiving user operations, and a bus 90H connecting the units, and has hardware configuration using an ordinary computer.

In the learning device 10 according to the embodiment described above, each of the units described above is implemented on a computer by the CPU 90D reading a computer program from the ROM 90E onto the RAM 90F and executing it.

The computer program for executing each of the above processes executed by the learning device 10 according to the embodiment described above may be stored in the HDD 90G. The computer program for executing each of the above processes executed by the learning device 10 according to the embodiment described above may be provided in a state of being incorporated in the ROM 90E in advance.

The computer program for executing the above processes executed by the learning device 10 according to the embodiment described above may be provided as a computer program product in an installable or executable file stored in a non-transitory computer-readable recording medium, such as a CD-ROM, a CD-R, a memory card, a digital versatile disc (DVD), and a flexible disk (FD). The computer program for executing the above processes executed by the learning device 10 according to the embodiment described above may be stored in a computer connected to a network, such as the Internet, and may be provided by being downloaded via a network. The computer program for executing the above processes executed by the learning device 10 according to the embodiment described above may be provided or distributed via a network, such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning device comprising:
one or more hardware processors configured to function as:
an output control unit to output pieces of model information including respective accuracy and performance of learning models with different sizes;
a receiving unit to receive input made by a user; and
a training unit to train one of the learning models represented by one of the pieces of model information selected by the user.

2. The learning device according to claim 1, wherein the one or more hardware processors are further configured to function as a model generation unit to generate one or more untrained models with different sizes by using a trained model,
wherein the output control unit outputs the model information for each of the learning models including the trained model and the untrained models.

3. The learning device according to claim 2, wherein the model generation unit generates the untrained models with different sizes by executing pruning and morphing, the pruning being executed to determine a channel number ratio between layers of the trained model, the morphing being executed to increase or reduce the number of channels included in the layers while maintaining the channel number ratio between the layers determined by the pruning.

4. The learning device according to claim 3, wherein the model generation unit adjusts the number of channels of each of the layers of the generated untrained model to a value satisfying a predetermined setting condition.

5. The learning device according to claim 2, wherein
the receiving unit receives input of the performance of the learning model to be generated, and
the model generation unit generates the untrained model with the performance indicated by the received input.

6. The learning device according to claim 2, wherein
the one or more hardware processors are further configured to function as an accuracy estimation unit to estimate the accuracy of the untrained model by using the trained mode, and
the output control unit outputs
the model information including the accuracy and the performance of the trained model, and
the model information including the estimated accuracy and performance of the untrained model.

7. The learning device according to claim 6, wherein the accuracy estimation unit estimates the accuracy of the untrained model by interpolation and extrapolation using the trained models.

8. The learning device according to claim 6, wherein the accuracy estimation unit estimates the accuracy of the untrained model generated by deletion of channels included in the trained model, the accuracy of the untrained model being estimated on the basis of: the accuracy of the trained model, importance of each of channels included in a layer of the trained model, and importance of each of the channels included in a layer of the untrained model.

9. The learning device according to claim 6, wherein the accuracy estimation unit estimates the accuracy of the untrained model by using one or more of the trained models each having a size difference from the untrained model being an accuracy estimation target, the size difference being equal to or smaller than a threshold value.

10. The learning device according to claim 6, wherein the accuracy estimation unit excludes, from the trained models used for accuracy estimation of the untrained model, the trained model whose change amount to the performance before resizing is equal to or smaller than a threshold value, in the trained models generated by the resizing.

11. The learning device according to claim 6, wherein the accuracy estimation unit estimates again the accuracy of the learning model in accordance with the changed model information when a change of the output model information is received.

12. The learning device according to claim 1, wherein the output control unit outputs a graph representing a relation between the accuracy and the performance included in each of the pieces of model information.

13. The learning device according to claim 1, wherein the output control unit outputs information indicating the number of channels and the performance of each of layers of the learning model defined by the model information.

14. The learning device according to claim 1, wherein the output control unit outputs a computation amount that is the performance included in the model information, the computation amount being output for each type of computation.

15. The learning device according to claim 1, wherein the output control unit outputs a change amount and the evaluation data, the change amount indicating a change between an inference result for evaluation data by the learning model before resizing and an inference result for the evaluation data by the learning model after the resizing.

16. A learning method comprising:
outputting pieces of model information including respective accuracy and performance of learning models with different sizes;
receiving input made by a user; and
training one of the learning models represented by one of the pieces of model information selected by the user.

17. A computer program product comprising a non-transitory computer-readable recording medium on which a program executable by a computer is recorded, the program instructing the computer to:
output pieces of model information including respective accuracy and performance of learning models with different sizes;
receive input made by a user; and
train one of the learning models represented by one of the pieces of model information selected by the user.

18. A learning system comprising:
a display device; and
one or more hardware processors configured to function as:
an output control unit to output, to the display device, pieces of model information including respective accuracy and performance of learning models with different sizes;
a receiving unit to receive input made by a user; and
a training unit to train one of the learning models represented by one of the pieces of model information selected by the user.
